(19) United States
(12) Patent Application Publication
(10) Pub. No.: US 2020/0293415 A1
(43) Pub. Date: Sep. 17, 2020

(54) MEMORY TRAINING

(71) Applicant: QUALCOMM Incorporated, San Diego, CA (US)

(72) Inventors: Sanku MUKHERJEE, Bangalore (IN); Uttkarsh WARDHAN, Bangalore (IN); Madan KRISHNAPPA, Bangalore (IN)

(21) Appl. No.: 16/354,573

(22) Filed: Mar. 15, 2019

(51) Int. Cl. G06F 11/22; G06N 20/00

(52) U.S. Cl. CPC G06F 11/2205; G06N 20/00; G06F 11/2284

(57) ABSTRACT

Certain aspects of the present disclosure generally relate to memory training. An example method generally includes assigning each of a plurality of data channels of a memory device to at least one processor, performing memory tests, in parallel, on the plurality of data channels by at least in part performing read and write operations on at least two or more of the plurality of data channels in parallel using the at least one processor, and determining a setting for one or more memory interface parameters associated with the memory device relative to a data eye for each of the plurality of data channels determined based on the memory tests.

### BACKGROUND

### Field of the Disclosure

Certain aspects of the present disclosure relate generally to semiconductor devices, and more particularly, to parallel training of memory.

### Description of Related Art

Portable computing devices (e.g., cellular telephones, smart phones, tablet computers, portable digital assistants (PDAs), portable game consoles, wearable devices, and other battery-powered devices) and other computing devices continue to offer an ever-expanding array of features and services, and provide users with unprecedented levels of access to information, resources, and communications. To keep pace with these service enhancements, such devices have become more powerful and more complex. Portable computing devices now commonly include a system-on-chip (SoC) having a plurality of memory clients embedded on a single substrate (e.g., one or more central processing units (CPUs), a graphics processing unit (GPU), digital signal processors (DSPs), etc.). The memory clients may read data from and store data in a memory, such as a dynamic random access memory (DRAM) electrically coupled to the SoC via a high-speed bus, such as, a double data rate (DDR) bus.

In source synchronous memory interfaces, such as Low Power Double Data Rate (LPDDR) memories and Double Data Rate (DDR) memories, crosstalk and Power Distribution Network (PDN) noise are key performance bottlenecks. The performance of a memory interface may be observed using eye diagram analysis techniques in which dimensions of an eye diagram aperture are indicative of signal integrity across the interface. Crosstalk and PDN noise may limit the maximum achievable frequency (fmax) of a memory interface. The limit on the maximum frequency can be observed as a limitation on dimensions of an eye aperture on an eye diagram. Various memory (e.g., DDR) interface parameter settings (e.g., memory clock frequency, bus clock frequency, latency, voltage, on-die termination, etc.) may be adjusted to improve the performance of the memory.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects of the present disclosure provide a method of calibrating a memory device. The method generally includes assigning each of a plurality of data channels of the memory device to at least one processor, performing memory tests, in parallel, on the plurality of data channels by at least in part performing read and write operations on at least two or more of the plurality of data channels in parallel using the at least one processor, and determining a setting for one or more memory interface parameters associated with the memory device relative to a data eye for each of the plurality of data channels determined based on the memory tests.

Certain aspects of the present disclosure provides a memory device. The memory device generally includes a memory comprising a plurality of data channels and at least one processor coupled to the memory. The at least one processor coupled to the memory may be configured to assign each of the plurality of data channels to the at least one processor, perform memory tests, in parallel, on the plurality of data channels by at least in part performing read and write operations on at least two or more of the plurality of data channels in parallel, and determine a setting for one or more memory interface parameters associated with the memory relative to a data eye for each of the plurality of data channels based on the memory tests.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is an illustration of an exemplary system-on-chip (SoC) integrated circuit design, in accordance with certain aspects of the present disclosure.

FIG. 2A is an illustration of example crosstalk encountered by circuits.

FIG. 2B is an illustration of example simultaneous switching output noise encountered by circuits.

FIG. 2C is an illustration of various memory interface signals with respect to time.

FIG. 3A illustrates a block diagram of an example memory device that may perform DDR memory training, in accordance with certain aspects of the present disclosure.

FIG. 3B is an illustration of an example channel coupling between the processor and memory of FIG. 3A, in accordance with certain aspects of the present disclosure.

FIG. 4 is a flow diagram of example operations to calibrate a memory device, in accordance with certain aspects of the present disclosure.

FIG. 5 is another flow diagram of example operations for performing memory training, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The term “computing device” may refer to any one or all of servers, personal computers, smartphones, cellular telephones, tablet computers, laptop computers, netbooks, ultrabooks, palm-top computers, personal data assistants (PDAs), wireless electronic mail receivers, multimedia Internet-enabled cellular telephones, Global Positioning System (GPS) receivers, wireless gaming controllers, and similar personal electronic devices which include a programmable processor. While the various aspects are particularly useful in mobile devices (e.g., smartphones, laptop computers, etc.), which have limited resources (e.g., processing power, battery, size, etc.), the aspects are generally useful in any computing device that may benefit from improved processor performance and reduced energy consumption.

The term “multicore processor” is used herein to refer to a single integrated circuit (IC) chip or chip package that contains two or more independent processing units or cores (e.g., CPU cores, etc.) configured to read and execute program instructions. The term “multiprocessor” is used herein to refer to a system or device that includes two or more processing units configured to read and execute program instructions.

The term “system-on-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors (DSPs), modem processors, video processors, etc.), memory blocks (e.g., ROM, RAM, flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include dynamic random-access memory (DRAM), static random-access memory (SRAM), non-volatile random-access memory (NVRAM), flash memory (e.g., embedded multimedia card (eMMC) flash), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory. Each of the above-mentioned memory technologies includes, for example, elements suitable for storing instructions, programs, control signals, and/or data for use in or by a computer or other digital electronic device. Any references to terminology and/or technical details related to an individual type of memory, interface, standard, or memory technology are for illustrative purposes only, and not intended to limit the scope of the claims to a particular memory system or technology unless specifically recited in the claim language. For example, certain aspects are described with respect to DDR memory, but may also be applicable to other suitable types of memory having a plurality of data channels. Mobile computing device architectures have grown in complexity, and now commonly include multiple processor cores, SoCs, co-processors, functional modules including dedicated processors (e.g., communication modem chips, GPS receivers, etc.), complex memory systems, intricate electrical interconnections (e.g., buses and/or fabrics), and numerous other resources that execute complex and power intensive software applications (e.g., video streaming applications, etc.).

### Example Semiconductor Device

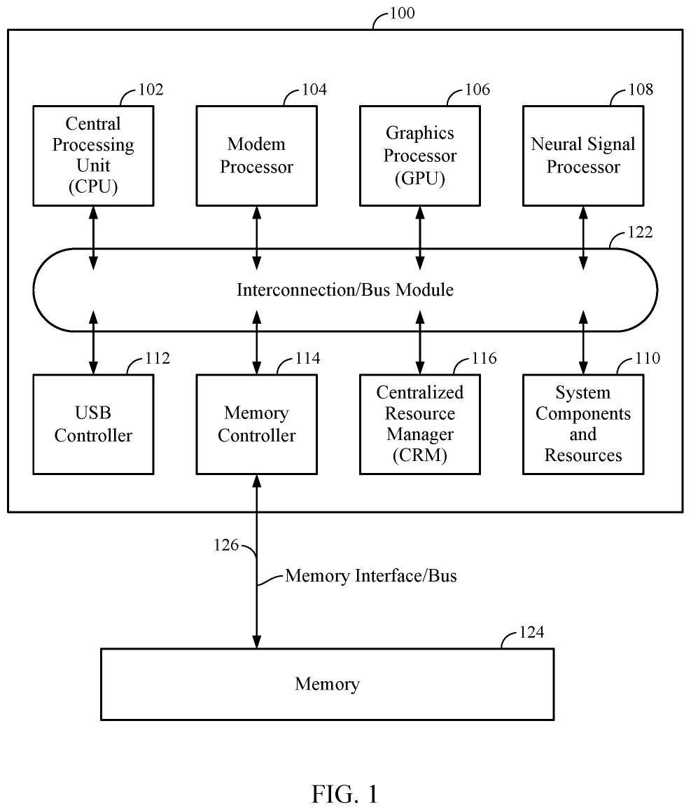

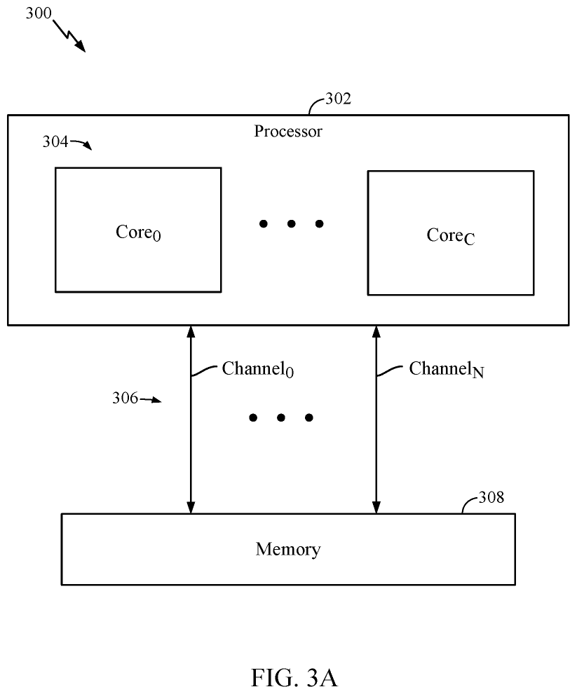

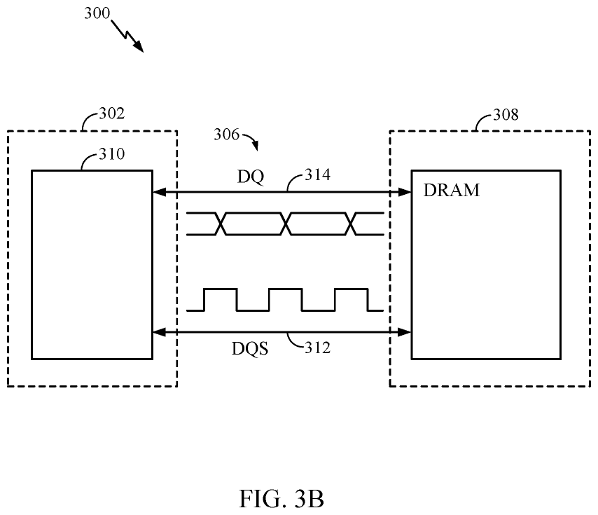

FIG. 1 illustrates example components and interconnections in a system-on-chip (SoC) 100 suitable for implementing various aspects of the present disclosure. The SoC 100 may include a number of heterogeneous processors, such as a central processing unit (CPU) 102, a modem processor 104, a graphics processor 106, and a neural signal processor (NSP) 108. Certain aspects of the present disclosure are generally related to training DDR memory channels using at least one of the processors 102, 104, 106, 108. For example, each of the cores included in the NSP 108 may train the DDR memory channels in parallel as further described herein with regard to FIGS. 3-5.

Each processor 102, 104, 106, 108, may include one or more cores, and each processor/core may perform operations independent of the other processors/cores. The processors 102, 104, 106, 108 may be organized in close proximity to one another (e.g., on a single substrate, die, integrated chip, etc.) so that the processors may operate at a much higher frequency/clock rate than would be possible if the signals were to travel off-chip. The proximity of the cores may also allow for the sharing of on-chip memory and resources (e.g., voltage rails), as well as for more coordinated cooperation between cores.

The SoC 100 may include system components and resources 110 for managing sensor data, analog-to-digital conversions, and/or wireless data transmissions, and for performing other specialized operations (e.g., decoding high-definition video, video processing, etc.). System components and resources 110 may also include components such as voltage regulators, oscillators, phase-locked loops (PLLs), peripheral bridges, data controllers, system controllers, access ports, timers, and/or other similar components used to support the processors and software clients running on the computing device. The system components and resources 110 may also include circuitry for interfacing with peripheral devices, such as cameras, electronic displays, wireless communication devices, external memory chips, etc.

The SoC 100 may further include a Universal Serial Bus (USB) controller 112, one or more memory controllers 114, and a centralized resource manager (CRM) 116. The SoC 100 may also include an input/output module (not illustrated) for communicating with resources external to the SoC, each of which may be shared by two or more of the internal SoC components.

The processors 102, 104, 106, 108 may be interconnected to the USB controller 112, the memory controller 114, system components and resources 110, CRM 116, and/or other system components via an interconnection/bus module 122, which may include an array of reconfigurable logic gates and/or implement a bus architecture (e.g., CoreConnect, AMBA, etc.). Communications may also be provided by advanced interconnects, such as high performance networks on chip (NoCs).

The interconnection/bus module 122 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the interconnection/bus module 122 may implement an arbitration scheme to prevent multiple master components from attempting to drive the bus simultaneously.

The memory controller 114 may be a specialized hardware module configured to manage the flow of data to and from a memory 124 (e.g., a DDR memory) via a memory interface/bus 126. The memory controller 114 may comprise one or more processors configured to perform read and write operations with the memory 124. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In certain aspects, the memory 124 may be part of the SoC 100.

### Example Memory Training

Advancements in DDR memory interfaces for complex SoCs (e.g., SoCs having heterogeneous processors such as the SoC 100 depicted in FIG. 1) encounter ever increasing demands for higher memory bandwidth, data-rates, and channel interface width. As the interface margins shrink, the DDR memory training operations may rely on extensive timing/voltage training. Further, as the channel widths increase, the DDR memory may also face degradation in signal and power integrity due to high simultaneous switching output (SSO) noise and electromagnetic crosstalk between electrical components.

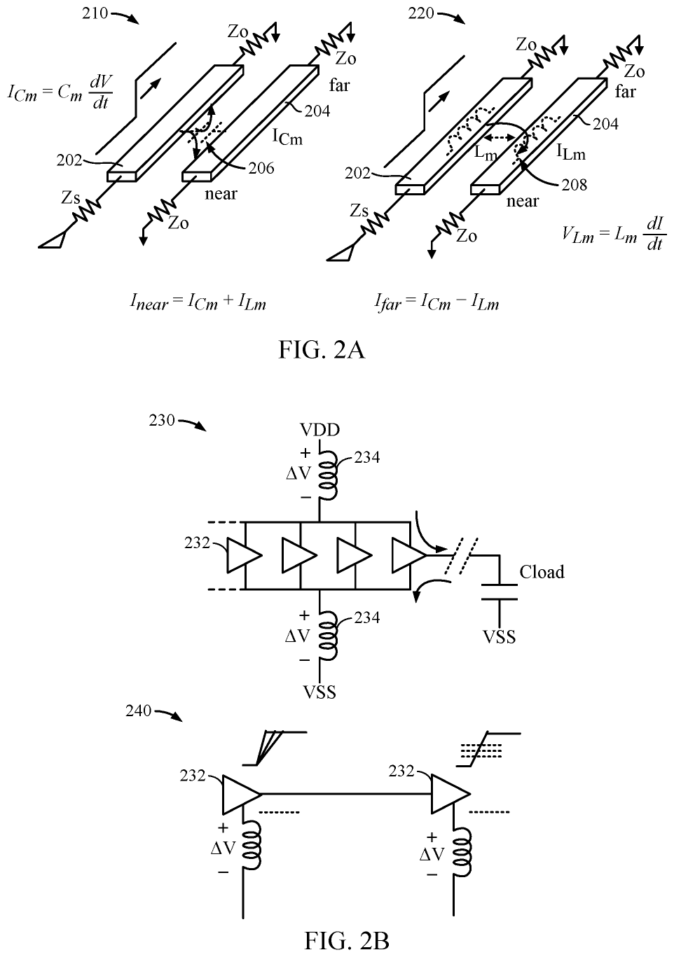

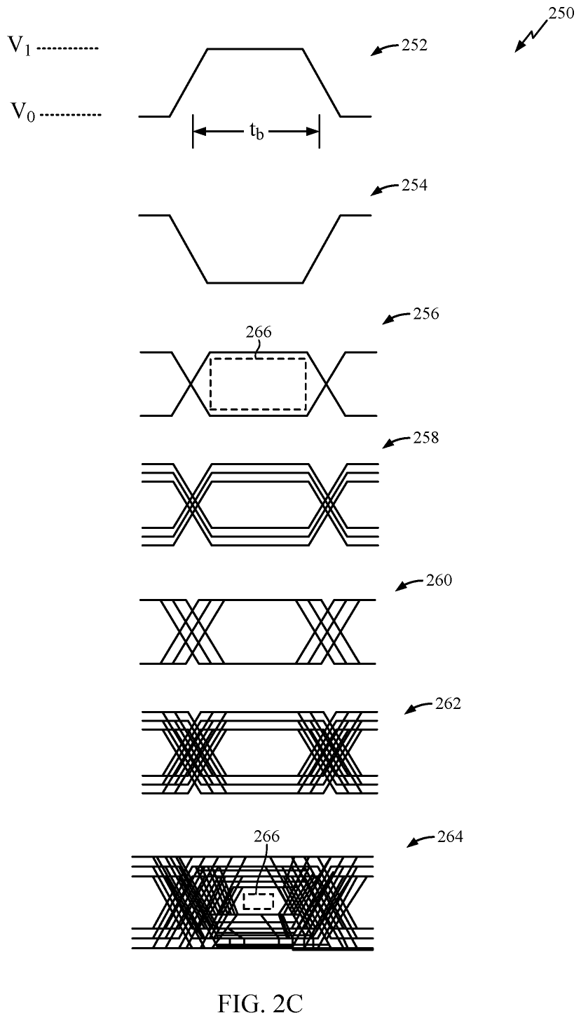

Electromagnetic crosstalk is one factor that may cause signal instability in DDR memory. As an example, FIG. 2A illustrates the crosstalk encountered by circuits 210, 220. As shown, the circuit 210 may exhibit a mutual capacitance 206 between electrical components 202, 204. The mutual capacitance 206 will pass current through the capacitance that flows in both directions on the victim line (e.g., electrical component 204). The circuit 220 illustrates a mutual inductance 208 produced between the electrical components 202, 204. Lenz's law provides that the mutual inductance 208 will induce current on the victim line (e.g., electrical component 204) opposite of the driving current (e.g., the electrical signal conducted through the electrical component 202).

SSO noise is another aspect that may cause signal instability in DDR memory. When several output buffers and/or receiver buffers are switched simultaneously, a significant current is drawn from the power supply or sent to ground, for example. Supply connections may have inductances, and SSO currents may produce a voltage drop across the supply inductances. For example, FIG. 213 shows a schematic view of an example circuit 230 having output buffers 232 coupled to a supply voltage VDD and a reference voltage VSS (e.g., ground). As shown, the supply voltage VDD and reference voltage VSS may have inherent inductances 234.

On-chip effects of the SSO noise may cause the voltage difference between the supply voltage VDD and ground VSS to decrease. Between chips, the SSO noise may cause variations in driver timing and shift the receiver threshold. For example, FIG. 2B also shows a circuit 240 having output buffers 232 experiencing variations in driver timing and shifts in the receiver threshold.

FIG. 2C illustrates various memory interface signals with respect to time and demonstrates the effects of multi-channel noise. As shown, the memory interface signal 254 is an example of a “1” without any noise, the memory interface signal 254 is an example of a “0” without any noise, and the memory interface signals 256 shows the eye aperture 266 between the “1” and “0” signals. The memory interface signals 258 show the crosstalk encountered with an additional DDR memory channel. The memory interface signals 260 show the SSO noise encountered with the additional channel. The memory interface signals 262 shows the SSO noise and crosstalk encountered with an additional channel. The memory interface signals 264 show the SSO noise and crosstalk encountered with eight additional channels. In general, as the DDR interface width increases, the SSO noise and crosstalk encountered by the DDR memory may also increase and the eye aperture decreases. The size of the eye aperture may reflect the reliability of the DDR interface. For example, a larger eye provides a larger margin of error within which to detect a data pulse level at a receiver.

The SoC may perform DDR memory training to determine the dimensions of the eye aperture for each DDR channel. Advancements in the DDR memory, such as increased channel interface width, may increase the test time (e.g., automatic test equipment (ATE) testing and/or system level testing (SLT)) of the SoC to perform DDR memory training. For instance, under current testing operations, the DDR memory channels are trained in serial during post-fabrication quality tests of the SoC and/or during a boot sequence of the SoC, resulting in ever increasing test times as the interface width of the DDR memory increases. The increased test time may also lead to increased manufacturing costs for each SoC and increased boot times experience by the end user of the SoC.

Aspects of the present disclosure are generally related to training DDR memory channels in parallel using one or more processors, which may reduce the amount of time to perform the DDR training. Running the DDR memory training in parallel may also expose the memory interfaces to conditions similar to live applications including multi-channel SSO noise and/or crosstalk such as the multi-channel noise depicted in FIG. 2C. The multi-channel noise excited during the DDR training may provide a more accurate representation of the data eye for memory calibration.

FIG. 3A illustrates a block diagram of an example memory device 300 that may perform the DDR memory training, in accordance with certain aspects of the present disclosure. As shown, the memory device 300 may include a processor 302 and a DDR memory 308. The processor 302 may be a multicore processor having one or more cores 304, which may be homogenous or heterogeneous processing units. For example, in a homogenous system, the cores 304 may all operate at the same frequency and have identical processing capabilities. In a heterogeneous system, some of the cores 304 may operate at different frequencies and have different processing capabilities than the other cores 304.

In certain aspects, the processor 302 may have a neural signal processor (NSP) or any other suitable processing unit configured to perform machine learning operations. The NSP may be a machine learning core that is hardware accelerated to execute deep neural networks. For instance, each of the cores 304 may have one or more NSPs. In other aspects, each of the cores 304 may be an NSP. The NSP(s) may perform the memory tests, described herein, with machine-learning methods (e.g., classification, localization, detection, segmentation, and/or regression of the data eye for each data channel) to determine a setting for one or more memory interface parameters associated with the memory device relative to a data eye for each of the data channels. The NSP(s) may use various machine-learning models including an artificial neural network, support vector machine, regression model, or deep learning model to determine the setting for one or more memory interface parameters. The memory training described herein may use computational and logical abilities of multiple NSPs in a synchronized, parallelized fashion. The NSP(s) may perform write/read/compare operations in parallel to generate the data eyes and/or histograms of each memory channel. Once the data eyes are generated, the NSP(s) may perform a linear, binary, or gradient based search to determine the center of the data eye, which is the final outcome of the training operation. The search operations for the data eye may use machine learning operations.

Examples of the processors and/or cores include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The DDR memory 308 may have a plurality of data channels 306. The processor 302 may be coupled to the DDR memory 308 via the data channels 306. The memory device 300 may also include a memory controller (not shown), such as the memory controller 114 depicted in FIG. 1, configured to facilitate the flow of data to and from the DDR memory 308 via the data channels 306.

As shown, the DDR memory 308 may have N number of data channels 306, and the processor 302 may have C number of cores 304. In certain aspects, the N number of data channels may not equal the C number of cores. In other aspects, the N number of data channels may be equal to the C number of cores. As further described herein, the data channels may be assigned to the cores 304 according to a ratio of data channels per core.

FIG. 3B illustrates an example channel coupling between the processor 302 and the memory 308, in accordance with certain aspects of the present disclosure. As shown, the processor 302 and the memory 308 may transmit and receive data, via a memory controller 310 (e.g., the memory controller 114 shown in FIG. 1), using a data strobe signal (DQS) 312 and a data signal (DQ) 314. The data strobe signal 312 may be a reference signal that transitions between logical 0 and 1. The data signal 314 may be captured on the transitioning edge of the data strobe signal 312 on both the rising and falling edges. A data eye (e.g., the data eye 266 shown in FIG. 2C) may be generated when multiple captured data signals are superimposed on one another due to SSO and/or crosstalk as described herein. The rising time refers to the time to transition from logical 0 to 1, and the falling time refers to the time to transition from logical 1 to 0. The reference voltage (Vref) refers to the threshold voltage for differentiating a logical 1 and 0 on the data signal.

Memory training may determine dimensions of the data eye, which may correspond to a certain timing offset for the data probe signal and a certain value for the reference voltage. The memory training may implement various algorithms (e.g., parallel machine learning algorithms) for efficiently determining the data strobe signal offset and reference voltage value pair for various frequency operating points of the memory.

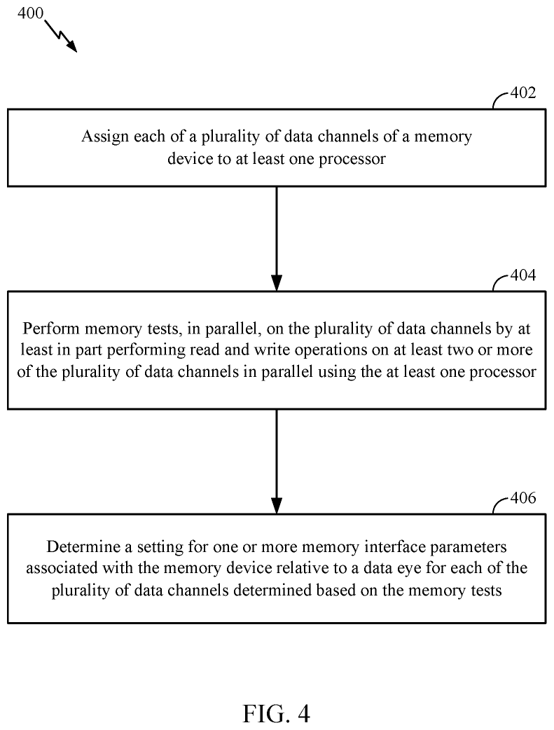

FIG. 4 is a flow diagram of example operations 400 to calibrate a memory device, in accordance with certain aspects of the present disclosure. The operations 400 may be performed by a memory device such as the memory device 300 depicted in FIG. 3.

The operations 400 may begin, at block 402, by a processor (e.g., processor 302 or processors 102, 108) assigning each of a plurality of data channels of the memory device to at least one processor (e.g., processors 102, 108; processor 302; or at least one of the cores 304). At block 404, the at least one processor performs memory tests, in parallel, on the plurality of data channels by at least in part performing read and write operations on at least two or more of the plurality of data channels in parallel. At block 406, the at least one processor determines a setting for one or more memory interface parameters associated with the memory device relative to a data eye for each of the plurality of data channels determined based on the memory tests.

The processor may determine preferable values for the interface parameters that improve or maximize the data eye dimensions for reliable detection of the data eye on each of the data channels. In memory training, timing offset parameters and reference voltage parameters for the logical 1 and 0 values may be determined to provide reliable detection of the data eye. Timing offsets between signals, such as the data probe signal (DQS) and data signal (DQ), may be controlled using circuits called Callibrated Delay Cells (CDC). The two-dimensional data eye (e.g., data eye 266 shown in FIG. 2C) is formed based on timing offset values along the x-axis and voltage reference values along the y-axis. The memory training may determine certain values of the timing offset and voltage reference that provide data transfer operations with the least impact from crosstalk, SSO, intersymbol interference (ISI), etc. In certain aspects, the one or more memory interface parameters may include at least one of a data probe signal timing offset, a data signal timing offset, or a reference voltage. The memory controller may adjust the one or more interface parameters to reduce the SSO noise and crosstalk and enhance the reliability of detecting the data eye across each of the data channels. For example, the memory interface frequency may depend on the traffic bandwidth requested from all memory clients, such as the cores 304. The memory interface frequency may rise or fall as the traffic bandwidth demand changes. Several voltage, frequency, offset bins may be used to adjust the eye patterns for each data channel depending on the traffic bandwidth demands. For each frequency operating point, the SoC, the physical channel, and the memory may be tuned during memory training to establish interface parameters that will provide reliable operation of the memory.

Performing the memory tests in parallel at block 402 may include performing read and write operations on at least two or more of the plurality of data channels simultaneously, which may generate the multi-channel noise depicted in FIG. 2C. For instance, read and write operations may be performed on Channel₀ through Channel_{N} as depicted in FIG. 3 simultaneously. In certain aspects, performing the memory tests at block 402 may include performing the memory tests, in parallel, across different address regions of the memory device. Testing the memory across different address regions may excite multi-channel noise (such as the noise depicted in FIG. 2C) and enable training the machine-learning models with a more accurate representation of the data-eye. In aspects, performing the memory tests at block 402 may include performing the memory tests, in parallel, using different data read and write patterns for each of the plurality of data channels. For instance, a sequence of read and write operations may be performed on Channel₀, and a different sequence of read and write operations may be performed on Channel_{N}. Performing the memory tests at block 402 may include sequentially performing different read and write patterns on each of the plurality of data channels. Sequentially performing different read and write patterns may excite multi-channel noise (such as the noise depicted in FIG. 2C) and enable training the machine-learning models with a more accurate representation of the data-eye.

In certain aspects, performing the memory tests at block 402 may include synchronizing a plurality of processors to perform read and write operations on the data channels at a same frequency and phase. Performing the memory tests while the processors are synchronized may enable the machine-learning models to train with multi-channel noise (such as the noise depicted in FIG. 2C) based on the synchronized state of the processors. For instance, hardware and/or software synchronizers (e.g., oscillators and/or PLLs) may be used across the cores 304 to synchronize execution of read/write operations to excite maximum noise in the data channels of the memory device.

In certain aspects, performing the memory tests at block 402 may include performing the read and write operations on the data channels across a range of frequencies and/or phase offsets. For example, in a heterogeneous system, the processor may perform the read and write operations at different frequencies. As another example, after writing test data at a certain frequency (e.g., a maximum operating frequency of the channels), the cores may perform read operations at a reduced frequency (e.g., 500 MHz less than the maximum). Performing the memory tests under a range of frequencies and/or phase offsets may enable the machine-learning models to train with multi-channel noise (such as the noise depicted in FIG. 2C) across a range frequencies and/or phase offsets.

In certain aspects, performing the memory test at block 402 may include training the write operations followed by training read operations. For instance, different clock delay circuit (CDCs) for phase control delays may be applied during write operations, until the data eye has been mapped for write operations, and preferable write CDC delays have been trained. After write training, the processor may write certain data patterns to the DDR memory (since write patterns have already been trained) and read back the data, for example, at the maximum operating frequency. CDC delays are then tuned to map the data eye for read operations and the preferable read CDC configurations are trained.

In certain aspects, performing the memory tests at block 402 may include performing the memory tests during a factory installation of a computing device (e.g., SoC 100) comprising the DDR memory device. For example, after manufacturing each SoC with a memory device, system quality tests, which may include performing memory training in parallel as described herein, may be performed. The parallel memory training described herein may enable faster quality tests to be performed, which further enable reduced fabrication costs.

In aspects, performing the memory tests at block 402 may include performing the memory tests during a boot process of a computing device comprising the DDR memory device. For example, during each boot sequence, the SoC may perform DDR memory training in parallel as described herein.

In certain aspects, at block 402, the processor may assign each of the plurality of data channels to a plurality of processors according to the processing capabilities. For instance, in heterogeneous systems, the SoC may include processors that have different processing capabilities, such as different operating frequencies or machine-learning capabilities. The processor may assign each of the plurality of data channels to processors that have the same operating frequency within the heterogeneous system. The processor may assign each of the plurality of data channels to processors that have the different operating frequency within the heterogeneous system, and the processors may use hardware or software synchronizers to perform the memory training at the same or similar frequencies. In other aspects, the processor may assign each of the plurality of data channels to processors that have machine-learning capabilities.

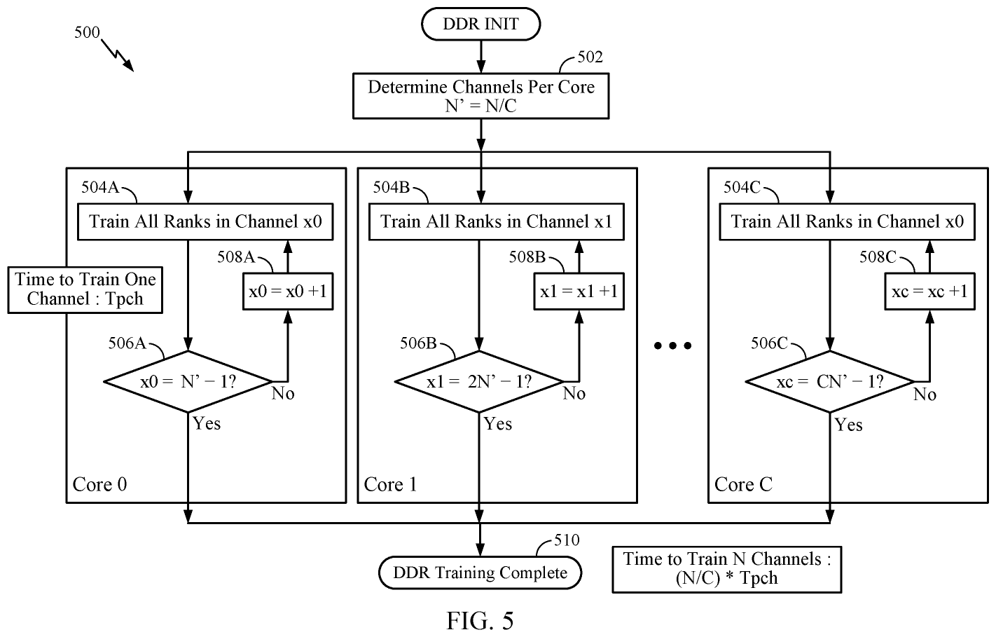

In certain aspects, the processor may assign more than one data channel to each of the processors. Each of the processors may simultaneously perform memory tests on the assigned data channels one-by-one. For example, FIG. 5 is another flow diagram of example operations 500 to perform memory training in parallel, in accordance with certain aspects of the present disclosure. The operations 500 may be performed by a memory device such as the memory device 300 depicted in FIG. 3.

The operations 500 may begin, at block 502, by a processor (e.g., processor 302 or processors 102, 108) determining the number of channels that may be assigned per core (N′=N/C, where N is total number of data channels to train, and C is the total number of cores available for training). For instance, the N number of data channels may be greater than the C number of cores, and each of the cores may be assigned more than one data channel to train. At blocks 504A, 504B, 504C, each of the cores (e.g., core₀, core₁, . . . core_{C}) may perform memory tests in parallel for a given data channel (e.g., channelₓ₀, channelₓ₁, . . . channel_{xc}). At blocks 506A, 506B, 506C, each of the cores may determine whether any more data channels in queue for training. At blocks 508A, 508B, 508C, if there is another data channel in queue for training, each of the cores may select that data channel for training at blocks 504A, 504B, 504C. If there are no more data channels in queue for training, the DDR training is complete at block 510, and the processor may continue with the boot sequence or quality testing as described herein. The total time to complete the DDR memory training may be given by the expression: (N/C)*T_{pch}, where T_{pch} is the amount of time that it takes a core to train a single data channel. In certain cases, the N number of data channels may be equal to the C number of cores, and each of the cores may be assigned one data channel to train. The total time to complete the DDR training may be equal to T_{pch}, providing a significant reduction the time to train the DDR memory in relation to serial training methods.

Aspects of the present disclosure provide various improvements to training memory. For instance, performing memory training in parallel as described herein may provide faster boot times for SoCs and enable the SoC to use less power during the boot sequence. Preforming memory training in parallel as described herein may enable the receivers to experience multi-channel noise as depicted in FIG. 2C, which may enable the SoC to determine more accurate values for the interface parameters that take into account multi-channel noise. Performing memory training in parallel as described herein may reduce the time taken to perform quality tests of the SoCs post-manufacture, and subsequently reduce the costs incurred due to training time.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein. The algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A method of calibrating a memory device, comprising:
assigning each of a plurality of data channels of the memory device to at least one processor;
performing memory tests, in parallel, on the plurality of data channels by at least in part performing read and write operations on at least two or more of the plurality of data channels in parallel using the at least one processor; and
determining a setting for one or more interface parameters associated with the memory device relative to a data eye for each of the plurality of data channels determined based on the memory tests.

2. The method of claim 1, wherein the at least one processor comprises at least one neural signal processor (NSP), and performing the memory tests comprises performing the memory tests with machine-learning methods using the at least one NSP.

3. The method of claim 1, wherein the at least one processor comprises a plurality of processors having different processing capabilities, and assigning each of the plurality of data channels comprises assigning each of the plurality of data channels to the processors according to the processing capabilities.

4. The method of claim 1, wherein performing the memory tests comprises performing the memory tests, in parallel, across different address regions of the memory device.

5. The method of claim 1, wherein performing the memory tests comprises performing the memory tests, in parallel, using different data read and write patterns for each of the plurality of data channels.

6. The method of claim 1, wherein performing the memory tests comprises sequentially performing different read and write patterns on each of the plurality of data channels.

7. The method of claim 1, wherein performing the memory tests comprises synchronizing a plurality of processors to perform read and write operations on the data channels at a same frequency and phase.

8. The method of claim 1, wherein performing the memory tests comprises performing the read and write operations on the data channels across a range of frequencies and phase offsets.

9. The method of claim 1, wherein performing the memory tests comprises performing the memory tests during a factory installation of a computing device comprising the memory device.

10. The method of claim 1, wherein performing the memory tests comprises performing the memory tests during a boot process of a computing device comprising the memory device.

11. The method of claim 1, wherein the one or more memory interface parameters comprises at least one of a data probe signal timing offset, a data signal timing offset, or a reference voltage.

12. A memory device, comprising:
a memory comprising a plurality of data channels; and
at least one processor coupled to the memory and configured to:
assign each of the plurality of data channels to the at least one processor,
perform memory tests, in parallel, on the plurality of data channels by at least in part performing read and write operations on at least two or more of the plurality of data channels in parallel, and
determine a setting for one or more memory interface parameters associated with the memory relative to a data eye for each of the plurality of data channels based on the memory tests.

13. The memory device of claim 12, wherein the at least one processor comprises at least one neural signal processor (NSP), and the at least one NSP is configured to perform the memory tests with machine-learning methods.

14. The memory device of claim 12, wherein the at least one processor comprises a plurality of processors having different processing capabilities, and the at least one processor is configured to assign each of the plurality of data channels comprises assigning each of the plurality of data channels to the processors according to the processing capabilities.

15. The memory device of claim 12, wherein the at least one processor is configured to perform the memory tests, in parallel, across different address regions of the memory.

16. The memory device of claim 12, wherein the at least one processor is configured to perform the memory tests, in parallel, using different data read and write patterns for each of the plurality of data channels.

17. The memory device of claim 12, wherein the at least one processor comprises a plurality of processors configured to synchronize the read and write operations on the data channels at a same frequency and phase.

18. The memory device of claim 12, wherein the at least one processor is configured to perform read and write operations on the data channels across a range of frequencies and phase offsets.

19. The memory device of claim 12, wherein the memory device is included in a computing device, and the at least one processor is configured to perform the memory tests during at least one of a factory installation of the computing device or a boot process of the computing device.

20. The memory device of claim 12, wherein the one or more memory interface parameters comprises at least one of a data probe signal timing offset, a data signal timing offset, or a reference voltage.
